(19) United States
(12) Patent Application Publication
(10) Pub. No.: US 2008/0080187 A1
(43) Pub. Date: Apr. 3, 2008

(54) Sealed LED light bulb

(76) Inventor: Richard S. Purinton, El Cajon, CA (US)

Correspondence Address: RICHARD D. CLARKE;LAW OFFICE OF RICHARD D. CLARKE, 3755 AVOCADO BLVD., #1000, LA MESA, CA, 91941-7301, US

(21) Appl. No.: 11/529,193

(22) Filed: Sep. 28, 2006

(51) Int. Cl. F21V 29/00

(52) U.S. Cl. 362/294

(57) ABSTRACT

The present invention is directed to a hermetically sealed LED light bulb with internal photo control circuit to be used in remote locations and harsh environments. The internal photo control circuit provides for either, a single LED or an array of LED's to turn on or off depending on the ambient light level. A hermetically sealed LED light bulb will include an internal photo control circuit including an LED and phototransistor mounted on a circuit board sealed by a glass dome connected to a base. The base of the sealed light bulb will have a variety of conventional attachment means including bayonet and threaded connection. With minor adjustments in the control circuit, the sealed LED light bulb will be available in variety of conventional voltages. A polymer or rubber sleeve will be provided to insure a sealed connection at the base.

### FIELD OF THE INVENTION

A wide variety of sealed light bulbs presently in varying voltages and mountings along with many types of motion and light sensors have existed for many years. The recent development of the LED lighting element operating on lower voltages has led to much advancement in this field. Operating on lower voltages, the LED dusk to dawn lighting has become more economical to operate and lasts many times longer than the average light bulb. Lighting in the past with LED's has required many elements to produce an appreciable amount of light but with the advanced development, more light can be produced by a single LED component. Additionally, the direction of the light can vary by the shape of the transparent covering. Many dusk to dawn lighting fixtures are in remote locations and are very difficult to access. It often requires a complicated operation to change these light bulbs. In the nautical field for example, boats operating at night are required to supply appropriate lighting. Those boats with tall masts are required to have lights on the top of the masts that are very difficult to replace when they burn out. This invention relates to a hermetically sealed LED light bulb with internal photo control circuit. The sealed LED light bulb has a responsive electronic circuit and more particularly switching circuitry combined with a single LED or LED array in a hermetically sealed housing, which is an integral part of a lamp base that has been designed to operate in a harsh salt water environment.

### BACKGROUND OF THE INVENTION

The requirement of frequent replacing of light bulbs in remote and inaccessible locations is a problem especially in marine industry where they are often placed on the top of tall masts of large boats. This inventor has endeavored to create a hermetically sealed light bulb housing one or more LED's, a control circuit and a phototransistor to provide a device that will be long lasting in a salt water environment and require a minimum amount of current. Photo controlled LED luminaries are well known and there is much prior art describing their assemblies.

U.S. Pat. No. 4,209,728 of Robert J. Membreno describes a lighting system for illuminating a given area is disclosed and includes a number of luminaries, each having a light source and a light sensitive device for automatically connecting the light source to a supply of power during the dark hours of the night and for automatically disconnecting the light source during the light hours of the day. This system also includes light control circuits associated with some but preferably not all of the luminaries. Each light control circuit overrides the operation of an associated light sensitive device and automatically disconnects its light source from the power supply for a predetermined period during the dark hours at a time when it is not important to provide a high degree of illumination.

This patent describes a very sophisticated lighting system involving a number of light sources. It does not deal with a single hermetically sealed LED light bulb with internal photo control circuit.

U.S. Pat. No. 6,724,156 of Gilbert Fregoso tells of a circuit that efficiently drives light emitting diodes (LED's). The circuit uses a switching regulator device instead of a standard resistor to limit current to the LED's. The switching regulator device is in a closed loop with a current sensing device near the LED lamps. Feedback from this current sensing device switches the control method according to the current load regulating the voltage applied to the LED's. An inductive storage device in the circuit allows the LED's to be driven with minimal voltage input. Methods for intensifying and focusing the light produced by the LED's driven by the circuit are also described.

This patent tells of a specific circuit to effectively drive and control the current load regulating the voltage to the LED's. It again does not deal with a single hermetically sealed LED light bulb with internal photo control circuit.

U.S. Pat. No. 6,709,126 of Monte A. Leen describes a nightlight having a base unit with a central cavity designed to house a light sensor and a printed circuit board. Mounted on the front surface of the base unit is a transversely aligned LED tube. The LED tube is disposed between two struts that extend forward from the front surface of the base unit. Attached to the front surface of the base unit and over the LED tube is a fixed half-spherical lens. Disposed over the lens is a rotating, half-spherical outer cap having an approximately quarter-spherical sized opening that allows a portion of the lens to be exposed so that light from the LED tube may be emitted there through. Thus, when the outer cap is selectively rotated around the base unit, the quarter-spherical sized opening is rotated therewith, and a dissipated broad beam of light may be selectively aimed in any direction.

This patent describes a nightlight with a conventional 110-volt connector to be used as an indoor nightlight. It has many of the same components but the LED's are housed in a separate tube with the circuit board and the light sensor in an unsealed cavity. It does not take advantage of the recent developments in the field of LED's and presents itself as a single purpose indoor nightlight. This device is not described as a hermetically sealed unit and could not be used in a remote, humid harsh environment, especially around salt water.

U.S. Pat. No. 6,709,132 of Kazuo Ishibashi provides an LED bulb with a higher distribution of luminous intensity which is close to those of tungsten bulbs, in which the problem in directivity of the prior art LED bulbs has been solved while maintaining the advantages of an LED. The LED bulb comprises a printed circuit board that is flat when developed and is bendable to form a cage, a plurality of LED's, which are disposed on the printed circuit board, and a transparent or semi-transparent cover that encloses the printed circuit board formed into the cage. The printed circuit board may have a plurality of belt-like branches, which extend in radial directions from the center of the printed circuit board. The LED bulb may further comprise a power unit housing for containing a power unit, which supplies electric current to each of the LED's.

This patent provides a 110-volt LED light bulb with a bendable circuit board having a plurality of LED's and a conventional threaded mounting base. It does not have the light sensing capabilities or the low voltage features that are described in the hermetically sealed LED light bulb with internal photo control circuit, and could not operate using a single LED or used in harsh environments.

U.S. Pat. No. 7,086,756 of Fedric S. Maxik tells of a lighting element that uses, as a source of light generation, electronically activated light emitting elements, such as light emitting diodes, organic crystals and the like to provide one or more functions and are surface mounted on a flexible substrate, such that the substrate can bend and conform to a pre-established structure. In addition, stand-offs of varying lengths are used to provide adjustable distances between the flexible substrate and the housing of the LED light bulb to provide adjustable light dispersion patterns. In this case, the circuit board is adapted to extend about and fit within the interior surface of a light bulb with the light emitting elements carried on the circuit board. A center post can be used to extend electrical conductors to the circuit board from the base and, if required, a power supply can be carried in the post. A portion of the circuit board itself could also effectively operate as the post. Methods for making same are also provided

This is another patent that provides a 110-volt LED light bulb with a bendable circuit board having a plurality of LED's and a conventional threaded mounting base. It does not have the light sensing capabilities or the low voltage features that are described in the hermetically sealed LED light bulb with internal photo control circuit, and could not operate using a single LED or work well in a salt water environment.

None of the foregoing prior art teaches or suggests the particular unique features of the hermetically sealed LED light bulb with internal photo control circuit and thus clarifies the need for further improvements in electrical lighting devices

### SUMMARY OF THE INVENTION

The invention is advantageous in that it involves the creation of a sealed LED light bulb to provide a light bulb that can operate for a long duration in remote locations.

Another advantage of the sealed LED light bulb is to provide a variety of light bulbs, both low voltage and high voltage incorporating a phototransistor, turning the bulb off and on depending on the ambient light.

A further advantage of the sealed LED light bulb is to provide a variety of light bulbs with a varied number of base connection means.

And, still another advantage of the sealed light bulb is to create a light bulb that will be long lasting even in an area with a corrosive environment, such as a salt water or marine environment.

An ever further advantage is that the device creates a sealed light bulb that can operate with one or more LED lighting components.

Still another advantage is having a device with the option of coming with a domed top LED shining the major portion of the light straight up or a conical top LED shining the major portion of the light 360 degrees to the sides.

A further advantage is to create a sealed light bulb with a sleeve to additionally seal the connection between the bulb and socket.

A further advantage is to create a sealed light bulb capable of giving off numerous colors of light depending upon the color of LED used and/or the color of the bulb dome used.

A yet further advantage of this invention is to add a new and unique device to the area of light bulbs.

These together with other advantages of the invention, along with the various features of novelty, which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention. There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

The hermetically sealed LED light bulb with internal photo control circuit provides for either a single LED or an array of LED's to turn on when ambient light levels are low enough and turn off when ambient light levels are high enough. The preferred embodiment of the hermetically sealed LED light bulb with internal photo control circuit would include a BA15 base. This will provide ease of installation in one step by inserting the base in a BA15 socket, although it must be understood that a wide variety of connection means and connection terminals including threaded bases are anticipated and will be covered within the scope of this patent. LED's are available where the major portion of the light is directed straight up or they are available where the major portion of the light is directed 360 degrees to the sides, both will be additionally covered within the scope of this patent. With minor adjustments in the control circuit, the sealed LED light bulb will be available in variety of conventional voltages. A polymer or rubber base sleeve will be provided to insure a sealed connection at the light base and the light fixture receiver. LED's have a long life span with the need to replace them measured in thousands of hours.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

### BRIEF DESCRIPTION OF THE DRAWINGS

The accompanying drawings, which are incorporated in and form a part of this specification, illustrate embodiments of the invention and together with the description, serve to explain the principles of this invention.

FIG. 1 depicts a perspective view of the hermetically sealed LED light bulb with internal photo control circuit having a bayonet mount with a single contact point.

FIG. 2 depicts an exploded perspective view of the hermetically sealed LED light bulb with internal photo control circuit.

FIG. 3 depicts a perspective view of the first alternate embodiment of the hermetically sealed LED light bulb having a bayonet mount with a two contact point base.

FIG. 4A depicts a perspective view of the second alternate embodiment of the hermetically sealed light bulb with a threaded base.

FIG. 4B depicts a perspective view of another alternate embodiment of the hermetically sealed light bulb with a push-in type base.

FIG. 5 depicts a perspective view of the alternate embodiment of the upper metal clad printed circuit board with a conical top LED.

FIG. 6 depicts a plan view of the upper metal clad printed circuit board.

FIG. 7 depicts a plan view of the fiberglass insulator.

FIG. 8 depicts an electrical schematic of the circuitry in the hermitically sealed light bulb.

FIG. 9 depicts a top plan view of the lower printed circuit board.

FIG. 10 depicts a bottom plan view of the lower printed circuit board.

FIG. 11 depicts an exploded view of a typical nautical lamp housing using the hermetically sealed light bulb with the base sleeve.

### DETAILED DESCRIPTION OF THE PREFERRED EMBODIMENTS

Referring now to the drawings, wherein similar parts of the sealed LED light bulbs 10A, 10B and 10C are identified by like reference numerals, there is seen in FIG. 1 a perspective view of the hermetically sealed LED light bulb 10A with internal photo control circuit having a bayonet mount base 12A with a single contact point 14. The single domed LED 16A is shown through the heavy glass dome 18 is attached to the expanded diameter shell 34. The shell 34 is integral to the base and has an expanded diameter to accommodate the parts hermetically sealed inside the shell when it is attached to the dome 18. In this way, the inner workings of the device are protected from the environment. The phototransistor 22 additionally appears through the heavy glass dome 18 attached to the upper metal clad printed circuit board 20. Integral to the mount base 12A is an expanded diameter shell 34. The heavy glass dome 18 is hermetically sealed to the shell 34. The heavy glass dome 18 may be replaced with domes made from a variety of materials and in a variety of colors as well as clear.

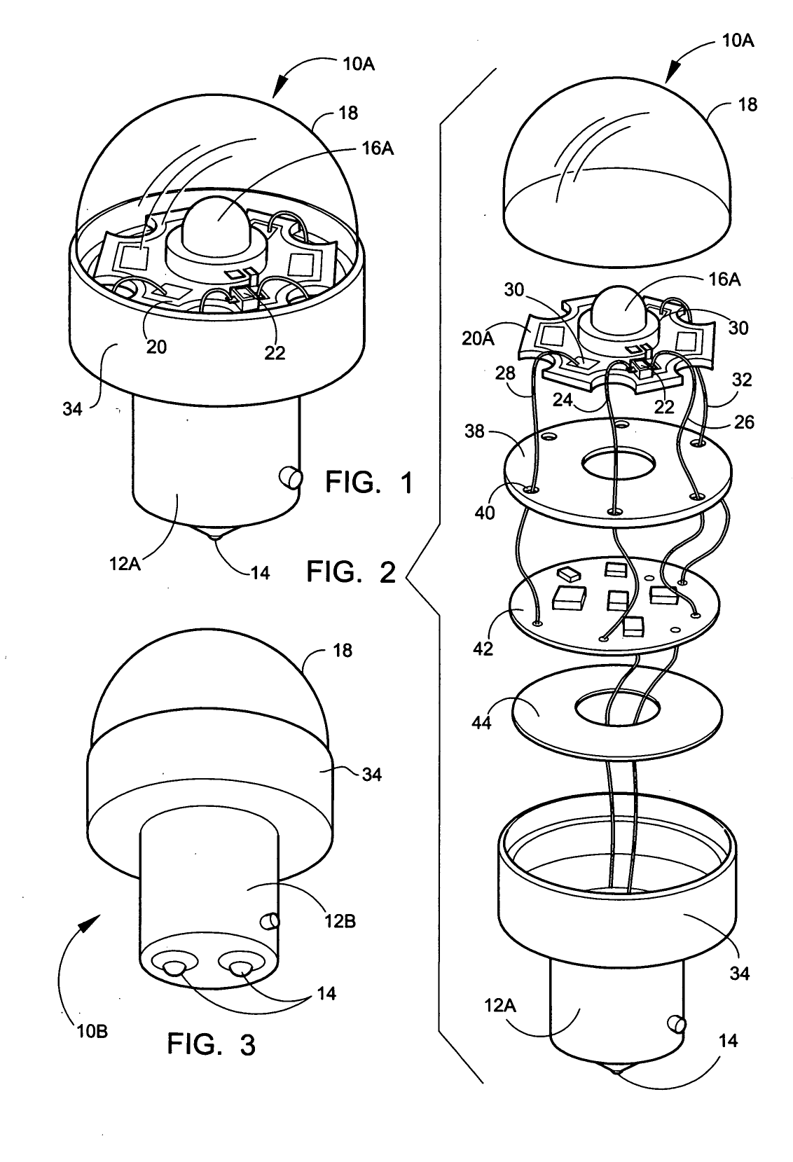

FIG. 2 depicts an exploded perspective view of the hermetically sealed LED light bulb 10A with the heavy glass dome 18 above the upper metal clad printed circuit board 20A exposing the phototransistor 22. The phototransistor anode wire 24 is connected to one side of the phototransistor 22 and the phototransistor cathode wire 26 is connected to the other side. An LED cathode wire 28 is shown connected to a weld pad 30 on the upper metal clad circuit board 20A with the LED anode wire 32 connected to another weld pad 30 on the upper metal clad circuit board 20. A fiberglass insulator 38 with a plurality of orifices 40 for the wiring to pass through separates the metal clad printed circuit board 20A from the lower double-sided printed circuit board 42. A Mylar insulator 44 separates the lower double sided printed circuit board 42 from the expanded diameter shell 34. The bayonet mount base 12A is shown with a single contact point 14. Although the material for the fiberglass insulator 38 and the Mylar insulator 44 has been specified it must at this time be clarified that a wide variety of conventional insulating materials may be used for this purpose and will still be covered within this patent.

FIG. 3 depicts a perspective view of the first alternate embodiment of the hermetically sealed LED light bulb 10B having a bayonet mount base 12B having two base contact points 14.

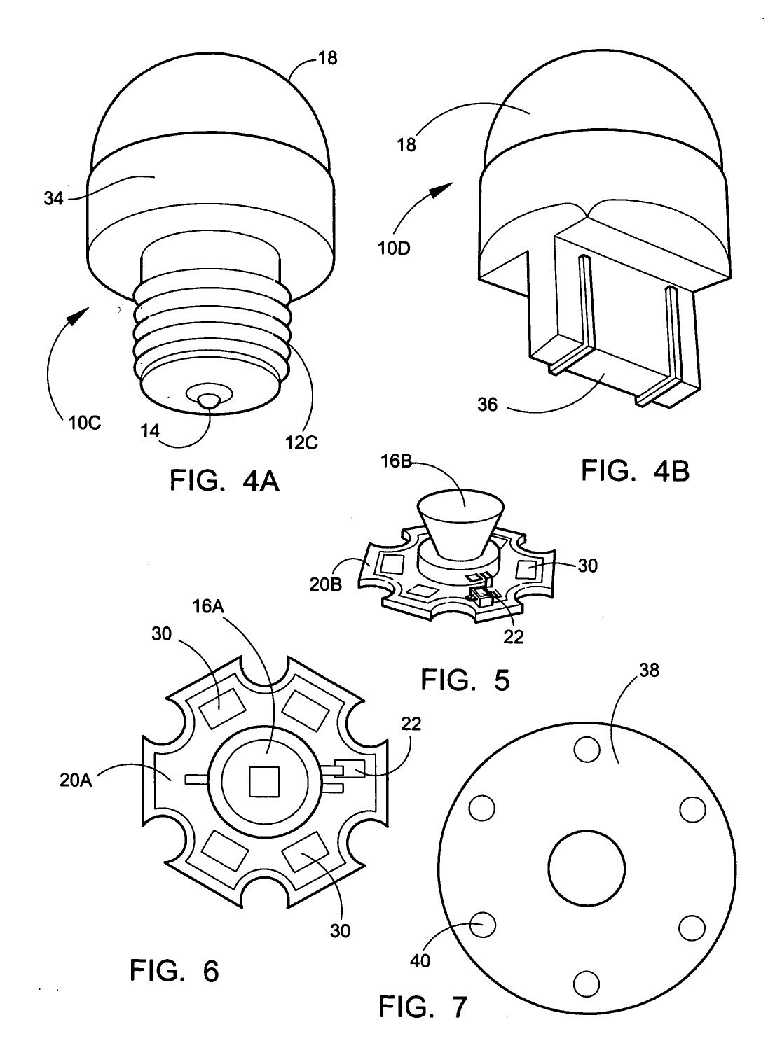

FIG. 4A depicts a perspective view of the second alternate embodiment of the hermetically sealed light bulb 10C with a threaded base mount 12C and a single contact point 14.

FIG. 4B depicts a perspective view of another alternate embodiment of the hermetically sealed light bulb 10D with a push-in type base mount 36.

FIG. 5 depicts a perspective view of the alternate embodiment of the upper metal clad printed circuit board 20B with the conical top LED 16B, the phototransistor 22 and the weld pads 30.

FIG. 6 depicts a plan view of the upper metal clad printed circuit board 20A with the domed top LED 16A showing the position of a phototransistor 22, and numerous weld pads 30. The configuration and lay out of the upper metal clad printed circuit board 20A may vary widely with application and in manufacture.

FIG. 7 depicts a plan view of the fiberglass insulator 38, showing a large centrally located orifice and six outer orifices, with only orifice 40 labeled.

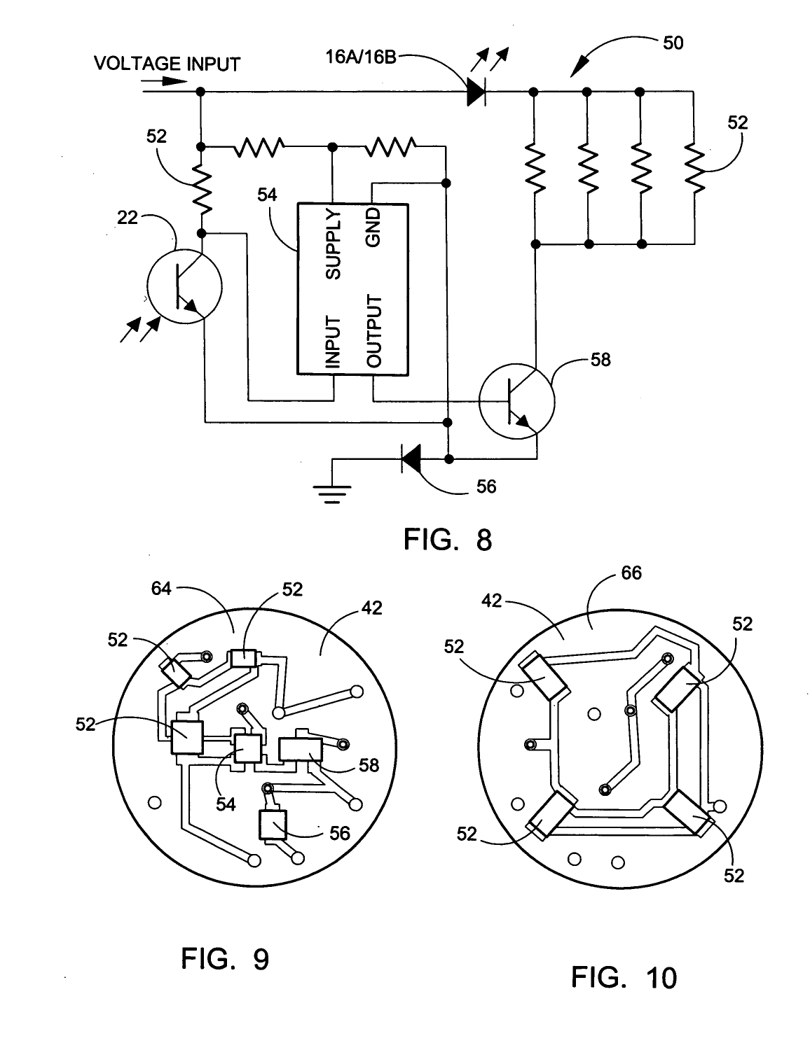

FIG. 8 is an electrical schematic 50 of the circuitry in the hermitically sealed light bulb 10A, 10B, 10C or 10D detailing resistors 52, phototransistor 22, the LED's 16A or 16B, the comparator 54, the diode 56 and the transistor 58.

FIG. 9 depicts a top plan view of the lower printed circuit board 42 displaying the upper surface 64 with the electrical components with FIG. 10 depicting a bottom plan view of the lower printed circuit board 42 displaying the lower surface 66 and the interconnecting electrical components.

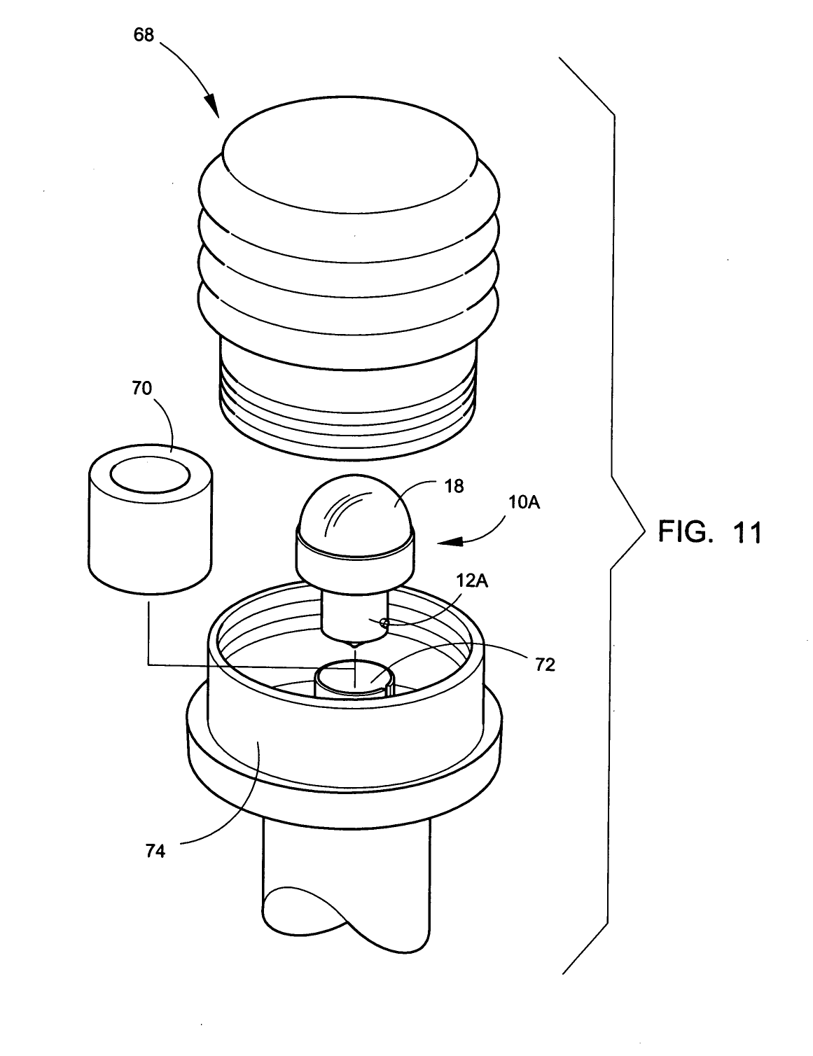

FIG. 11 depicts an exploded view of a typical nautical lamp housing 68 using the hermetically sealed light bulb 10A with the protective base sleeve 70. The base sleeve 70 has been designed as a moisture barrier and to further insulate the light bulb base units 12A, 12B or 12C and the nautical lamp housing bulb receiver 72 located in the nautical lamp housing base 74.

Some of the numerous varying uses for the present inventive sealed LED light bulb invention include: in the marine products area, as an anchor light, boat utility light, mooring buoy light, gangway light, cabin light, navigation light and as a dingy light. In the automotive area: as an engine compartment light, a trunk compartment light, and as a truck bed cargo light. In the recreational vehicle (RV) area: as a porch light, a step light, outdoor utility light, indoor utility light, indoor ceiling light, and as a utility trailer light. In the residential area, as a step light, path light, house number light, closet light, bathroom light and as an inside cabinet light.

The sealed LED light bulbs 10A, 10B, 10C and 10D shown in the drawings and described in detail herein disclose arrangements of elements of particular construction and configuration for illustrating preferred embodiments of structure and method of operation of the present invention. It is to be understood, however, that elements of different construction and configuration and other arrangements thereof, other than those illustrated and described may be employed for providing a sealed LED light bulbs 10A, 10B and 10C in accordance with the spirit of this invention. Such changes, alternations and modifications as would occur to those skilled in the art are considered to be within the scope of this invention, as broadly defined in the appended claims.

Further, the purpose of the foregoing abstract is to enable the U.S. patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

I claim:

1. A sealed light emitting diode (LED) light bulb comprising:
(a) a base having an integral expanded diameter shell with a flat lower surface, and one or more electrical contact points;
(b) an LED light source and a phototransistor both electrically mounted to a metal clad printed circuit board, and a two-sided printed circuit board having an upper side and a lower side;
(c) a fiberglass insulator and a Mylar insulator; and
(d) a protective cover dome
whereby said metal clad printed circuit board is in electrical communication with said two-sided printed circuit board and said two-sided circuit board is in electrical communication with said one or more electrical contacts on said base, and
further whereby said fiberglass insulator is sandwiched between said metal clad printed circuit board, said Mylar insulator is sandwiched between said two-sided printed circuit board and said flat lower surface of said integral expanded diameter shell, with said shell hermetically sealed to said protective cover dome, forming a sealed bulb, thereby protecting all of the electrical circuitry, the LED and the phototransistor inside the sealed bulb.

2. The sealed LED bulb according to claim 1, wherein said base having an integral expanded diameter shell with a flat lower surface, and one or more electrical contact points, includes a base adaptable to any conventional light bulb receiver.

3. The sealed LED bulb according to claim 2, wherein said base includes a bayonet base having a single contact point.

4. The sealed LED bulb according to claim 2, wherein said base includes a bayonet base having a two or more contact points.

5. The sealed LED bulb according to claim 2, wherein said base is a screw type threaded base having one or more contact points.

6. The sealed LED bulb according to claim 2, wherein said base is a push-in type base having one or more contact points.

7. The sealed LED bulb according to claim 1, wherein said LED light source is any conventional LED light source.

8. The sealed LED bulb according to claim 7, wherein said LED light source is a domed top LED.

9. The sealed LED bulb according to claim 7, wherein said LED light source is a conical top LED.

10. The sealed LED bulb according to claim 1, wherein said protective dome cover is translucent or opaque, clear or colored.

11. A method for making a sealed LED bulb comprising the steps of:
(a) providing a base having an integral expanded diameter shell with a flat lower surface, and one or more electrical contact points;
(b) providing an LED light source and a phototransistor both electrically mounted to a metal clad printed circuit board, and a two-sided printed circuit board having an upper side and a lower side;
(c) providing a fiberglass insulator and a Mylar insulator;
(d) providing a protective cover dome;
(e) wiring said metal clad printed circuit board in electrical communication with said two-sided printed circuit board and wiring said two-sided circuit board in electrical communication with said one or more electrical contacts on said base;
(f) positioning said fiberglass insulator between said metal clad printed circuit board;
(g) positioning said Mylar insulator between said two-sided printed circuit board and said flat lower surface of said integral expanded diameter shell;
(h) hermetically sealing said shell to said protective cover dome, forming a sealed bulb, thereby protecting all of the electrical circuitry, the LED and the phototransistor inside the sealed bulb.

12. The method for making a sealed LED bulb according to claim 11, wherein said step of providing a base having an integral expanded diameter shell with a flat lower surface, and one or more electrical contact points, includes the step of providing a base adaptable to any conventional light bulb receiver.

13. The method for making a sealed LED bulb according to claim 12, wherein said step of providing a base having an integral expanded diameter shell with a flat lower surface, and one or more electrical contact points, includes the step of providing a base wherein said base includes a bayonet base having a single contact point.

14. The method for making a sealed LED bulb according to claim 12, wherein said step of providing a base having an integral expanded diameter shell with a flat lower surface, and one or more electrical contact points, includes the step of providing a base wherein said base includes a bayonet base having a two or more contact points.

15. The method for making a sealed LED bulb according to claim 12, wherein said step of providing a base having an integral expanded diameter shell with a flat lower surface, and one or more electrical contact points, includes the step of providing a base, wherein said base is a screw type threaded base having one or more contact points.

16. The method for making a sealed LED bulb according to claim 12, wherein said step of providing a base having an integral expanded diameter shell with a flat lower surface, and one or more electrical contact points, includes the step of providing a base, wherein said base is a push-in type base having one or more contact points.

17. The method for making a sealed LED bulb according to claim 11, wherein said step of providing an LED light source and a phototransistor both electrically mounted to a metal clad printed circuit board further includes the step of providing any conventional LED light source.

18. The method for making a sealed LED bulb according to claim 17, wherein said step of providing an LED light source and a phototransistor both electrically mounted to a metal clad printed circuit board further includes the step of providing a domed top LED.

19. The method for making a sealed LED bulb according to claim 17, wherein said step of providing an LED light source and a phototransistor both electrically mounted to a metal clad printed circuit board further includes the step of providing a conical top LED.

20. The method for making a sealed LED bulb according to claim 11, wherein said step of providing a protective cover dome further includes the step of providing a protective cover dome that is translucent or opaque, clear or colored.
